(19) United States
(12) Patent Application Publication
(10) Pub. No.: US 2014/0142990 A1
(43) Pub. Date: May 22, 2014

(54) PERFORMANCE MEASUREMENT REPORTING SYSTEM AND METHOD FOR INSURANCE INDUSTRY

(71) Applicant: Syntel, Inc., Troy, MI (US)

(72) Inventor: Chetan Manjarekar, Balewadi, Pune (IN)

(21) Appl. No.: 14/083,704

(22) Filed: Nov. 19, 2013

Related U.S. Application Data
(60) Provisional application No. 61/728,043, filed on Nov. 19, 2012.

(51) Int. Cl. G06Q 40/00

(52) U.S. Cl. CPC G06Q 40/08
USPC 705/4

(57) ABSTRACT

A computerized system and method for visualizing business data, such as key performance indicators (“KPIs”), in a dashboard. This allows organizations to better understand the data to improve performance at various levels, increase focus on strategy and results, align organization strategy with execution on a day-to-day basis, and focus on drivers of future growth. In one embodiment, the system generates a set of pre-defined analytical reports viewable in the dashboard, which enable business users to measure, monitor, and manage KPIs across various business functions.

### RELATED APPLICATIONS

This application claims the benefit of U.S. Provisional Application Ser. No. 61/728,043, filed Nov. 19, 2012, entitled “Performance Measurement Reporting System and Method” which is hereby incorporated by reference in its entirety.

### TECHNICAL FIELD

This disclosure relates generally to computerized systems and processes; in particular, this disclosure relates to a computerized system and method for visualizing business data through a dashboard.

### BACKGROUND AND SUMMARY

Many organizations define goals and measure performance using key performance indicators (“KPIs”). In the insurance industry, for example, organizations have many challenges, including reducing claim rejections, analyzing costs, monitoring operations, tracking service level agreements (“SLAs”), ensuring best customer services, and adherence to regulatory compliance. The goals and performance in these areas can be challenging to visualize so that areas that need improvement can be identified.

Insurance organizations can greatly benefit by achieving data mastery and have an information advantage to capitalize on the existing wealth of data to fuel growth. Being able to understand data is a key to knowing what is going on with the business. This can help improve enterprise organization performance at various levels, increase focus on strategy and results, align organization strategy with execution on a day-to-day basis, and focus on drivers of future growth.

According to one aspect, the invention provides a system that generates a set of pre-defined analytical reports which enable business users to measure, monitor, and manage KPIs across various business functions. In this illustrative embodiment, users may access this information through a single point of access, such as using a dashboard.

The dashboard provides a rich user experience through charts and graphs and allows the users to easily drill down into individual reports. The system provides deep insight into business performance, which allows faster decision making and enhances customer retention and loyalty.

In one embodiment, the deployment of the system may include an analysis of source data that will be provided to the system. Upon analyzing the source data, the data architecture can be designed. This may involve the design of a logical and physical data model. The deployment process may include the design of a suitable dashboard or reporting system. This provides better data visualization at different levels of granularity and multi-dimensional analysis for better decision making. The user may select the types of business data to visualize in the dashboard.

Additional features and advantages of the invention will become apparent to those skilled in the art upon consideration of the following detailed description of the illustrated embodiment exemplifying the best mode of carrying out the invention as presently perceived. It is intended that all such additional features and advantages be included within this description and be within the scope of the invention.

### BRIEF DESCRIPTION OF THE DRAWINGS

The present disclosure will be described hereafter with reference to the attached drawings which are given as non-limiting examples only, in which:

FIG. 1 is a digrammatical view of an example computing device that may be included in the system and that may be programmed to carry out various methods taught herein according to one embodiment of the invention;

FIG. 2 is a high level digrammatical view of the system according to one embodiment of the invention;

FIG. 3 is a partial diagrammatical view of the system shown in FIG. 3;

FIG. 4 is an example screenshot with a login screen for the system according to one embodiment of the invention;

FIG. 5 is an example screenshot showing a user interface that could be used with the system according to one embodiment of the invention; and

FIGS. 6-11 are example screenshots showing various views of an example dashboard that could be provided by the system according to one embodiment of the invention.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

This disclosure relates generally to a computerized system and method for visualizing business data, such as key performance indicators (“KPIs”), in a dashboard. This allows organizations to better understand the data to improve performance at various levels, increase focus on strategy and results, align organization strategy with execution on a day-to-day basis, and focus on drivers of future growth. In the insurance industry, for example, the system facilitates business performance measurement across the insurance lifecycle. Although the system will be described in terms of the insurance industry, the system could be used in various environments in which performance indicators are measured.

In one embodiment, the system provides a comprehensive set of pre-defined analytical reports enabling business users to measure, monitor and manage KPIs across various business functions. For purposes of example only, an embodiment is contemplated in which the system provides approximately 60 KPIs that can be measured and monitored. In this illustrative embodiment, users may access this information through a single point of access, such as using a dashboard. The dashboard provides a rich user experience through charts and graphs and allows the users to easily drill down into individual reports. The system provides deep insight into business performance, which allows faster decision making and enhances customer retention and loyalty. In the insurance environment, the system would typically use an insurance industry based data model. Embodiments are contemplated in which the system provides role-based access so the information most pertinent to a particular user is presented.

In one embodiment, the system provides KPIs in the following non-exhaustive example categories:

| Categories | KPI | Metrics |
|---|---|---|
| Customer | Campaign budgeting | Campaigns analysis |
| Intelligence | analysis | |
| Customer | Cross sell - up sell | Customer growth |
| Intelligence | analysis | |
| Customer | Customer acquisition | Customer acquisition |
| Intelligence | | |
| Customer | Customer retention | Lost customer analysis |
| Intelligence | | |
| Financial | Premium Growth | Gross (GWP) growth |
| Financial | Premium Growth | Earned premium growth |
| Financial | Premium Growth | Net premium |
| Financial | Underwriting Gain/Loss | Net Underwriting gain/Loss |
| Financial | Overall operations gain | Overall Gain from |
| | | Operations |
| Financial | Maintaining Ratios | Overall Operating Ratio or |
| | | Net Combined operating |
| | | ratio |
| Financial | Maintaining Ratios | Claims Ratio |
| Financial | Maintaining Ratios | Business performance |
| Financial | Maintaining Ratios | Combined Ratio |
| Financial | Maintaining Ratios | Capacity Ratios |
| Actuary | Product performance | Product distribution |
| | | analysis |
| Actuary | Portfolio development | Portfolio development |
| Actuary | Financial | Loss ratio analysis |
| Product | Product distribution | Product performance |
| Performance | analysis | |
| Underwriting | Monitoring | TAT (turnaround time) |
| | | analysis |
| Underwriting | Monitoring | Quote policy hit ratio |
| | | analysis |
| Underwriting | Risk evaluation and | Risk classification report |
| | assessment | |
| Underwriting | Risk evaluation and | Application rejection ratio |
| | assessment | |
| Underwriting | Risk evaluation and | Application |
| | assessment | acceptance ratio |
| Underwriting | Risk evaluation and | Underwriting exposure |
| | assessment | analysis/Catastrophe loss |
| Underwriting | Financial | Underwriting cost analysis |
| Claims | Processing perspective | Claims Settlement |
| | | Efficiency/Speed ratio of |
| | | claims settlement |
| Claims | Operational perspective | Claim paid amount as |
| | | a % of first year |
| | | premium/renewal |
| | | premium |
| Claims | Financial perspective | Claims payment analysis |
| Claims | Financial perspective | Incurred Claims Ratio |
| Claims | Financial perspective | Claims Handling Expense |
| | | Ratio |
| Claims | Financial perspective | Reserve V/s Actual Claims |
| | | Paid |
| Claims | Financial perspective | Reinsurance Recovery Rate |
| Claims | Financial perspective | Claims Recovery |
| Claims | Financial perspective | Claims loss ratio |
| Claims | Financial perspective | Average cost per claim |
| Claims | Financial perspective | Large Claim Analysis |
| Claims | Efficiency perspective | Litigation claims analysis |
| Claims | Efficiency perspective | Inactive Claims KPI |
| Claims | Efficiency perspective | Claims Rejection Ratio |
| Claims | Efficiency perspective | Claims Complaints analysis |
| Claims | Efficiency perspective | Top claim cause |
| Claims | Efficiency perspective | Claims Fraud analysis |
| Claims | Efficiency perspective | Reopened Claims |
| Claims | Efficiency perspective | Claims adjustor's |
| | | productivity analysis |
| Sales & Agency | Financial | Business performance |
| Management | | |
| Sales & Agency | Financial | Cost of Premium |
| Management | | Acquisition |
| Sales & Agency | Financial | Claims Ratio |
| Management | | |
| Sales & Agency | Financial | Cost of Claims - Claims |
| Management | | Expenses |
| Sales & Agency | Financial | Total Commission pay out |
| Management | | |
| Sales & Agency | Customer Analysis | Customer base analysis - |
| Management | | Total customer base |
| | | and new customers |
| | | added |
| Sales & Agency | Business stability/growth | Lapse Analysis |
| Management | | |
| Sales & Agency | Business stability/growth | Customer retention rate (% |
| Management | | policy renewal rate) |
| Sales & Agency | Business stability/growth | Business lost |
| Management | | |
| Sales & Agency | Business stability/growth | $ average policy size |
| Management | | |
| Sales & Agency | Campaign analysis | Lead Performance |
| Management | | |
| Sales & Agency | Campaign analysis | New business pipeline |
| Management | | |
| Sales & Agency | Campaign analysis | Customer response ratio for |
| Management | | sales campaigns |

In one embodiment, the deployment of the system may include an analysis of source data that will be provided to the system. For example, the data quality of the source data could be analyzed. By way of another example, the source data could be analyzed to identify source metadata. This analysis allows a better understanding of the source data and potentially helps in better integrating the system.

Upon analyzing the source data, the data architecture can be designed. This may involve the design of a logical and physical data model. A metadata architecture may also be designed. This allows a service-oriented architecture to be designed. Additionally, the data architecture may be designed to share data with third party administrators and other stakeholders depending upon the circumstances.

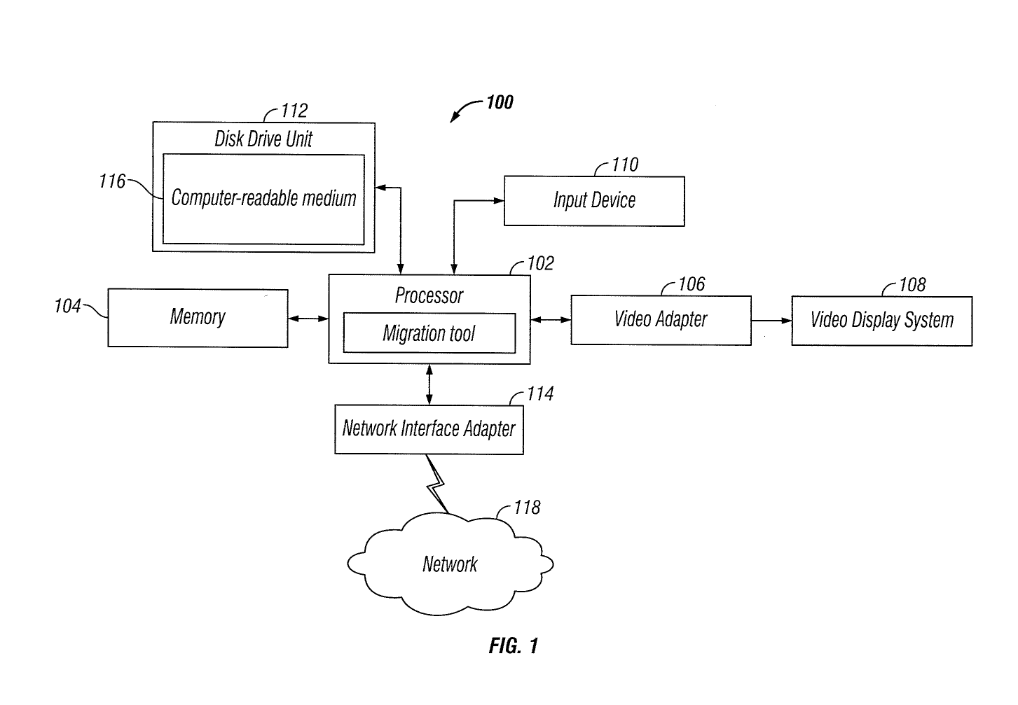

The deployment process may include the design of a suitable dashboard or reporting system. For example, a schematic layer may be designed. The dashboard layout and report formats may be designed and developed. This provides better data visualization at different levels of granularity and multi-dimensional analysis for better decision making. The user may select the types of business data to visualize in the dashboard and FIG. 1 illustrates a diagrammatic representation of a computing device 100 that may be programmed with a set of instructions to perform any one or more of the methods discussed herein. The computing device 100 may be any machine or computer capable of executing a set of instructions that specify actions to be taken by that computer.

The computing device 100 may operate as a standalone device or may be connected (e.g., networked) to other machines. In embodiments where the computing device is a standalone device, the set of instructions could be a computer program stored locally on the device that, when executed, causes the device to perform one or more of the methods discussed herein. In embodiments where the computer program is locally stored, data may be retrieved from local storage or from a remote location via a network. In a networked deployment, the computing device 100 may operate in the capacity of a server or a client machine in a server-client network environment, or as a peer machine in a peer-to-peer (or distributed) network environment. Although only a single machine is illustrated in FIG. 1, the term “computing device” shall also be taken to include any collection of machines that individually or jointly execute a set (or multiple sets) of instructions to perform any one or more of the methods discussed herein.

The example computing device 100 illustrated in FIG. 1 includes a processor 102 (e.g., a central processing unit (“CPU”)), a memory 104, a video adapter 106 that drives a video display system 108 (e.g., a liquid crystal display (“LCD”) or a cathode ray tube (“CRT”)), an input device 110 (e.g., a keyboard, mouse, touch screen display, etc.) for the user to interact with the program, a disk drive unit 112, and a network interface adapter 114. Note that various embodiments of the computing device 100 will not always include all of these peripheral devices.

The disk drive unit 112 includes a computer-readable medium 116 on which is stored one or more sets of computer instructions and data structures embodying or utilized by one or more of the methods described herein. The computer instructions and data structures may also reside, completely or at least partially, within the memory 104 and/or within the processor 102 during execution thereof by the computing device 100; accordingly, the memory 104 and the processor 102 also constitute computer-readable media. Embodiments are contemplated in which the instructions associated with the dashboard described herein may be transmitted or received over a network 118 via the network interface adaptor 114 utilizing any one of a number of transfer protocols including but not limited to the hypertext transfer protocol (“HTTP”) and file transfer protocol (“FTP”). The network 118 may be any type of communication scheme including but not limited to fiber optic, wired, and/or wireless communication capability in any of a plurality of protocols, such as TCP/IP, Ethernet, WAP, IEEE 802.11, or any other protocol. For example, embodiments are contemplated in which the dashboard functionalities may be provided as a web-based application running on a browser and accessible via the Internet or other communications network.

While the computer-readable medium 116 is shown in the example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing a set of instructions for execution by the computing device and that cause the computing device to perform any one or more of the methods described herein, or that is capable of storing data structures utilized by or associated with such a set of instructions. The term “computer-readable medium” shall accordingly be taken to include, but not be limited to, solid-state memories, optical media, flash memory, and magnetic media.

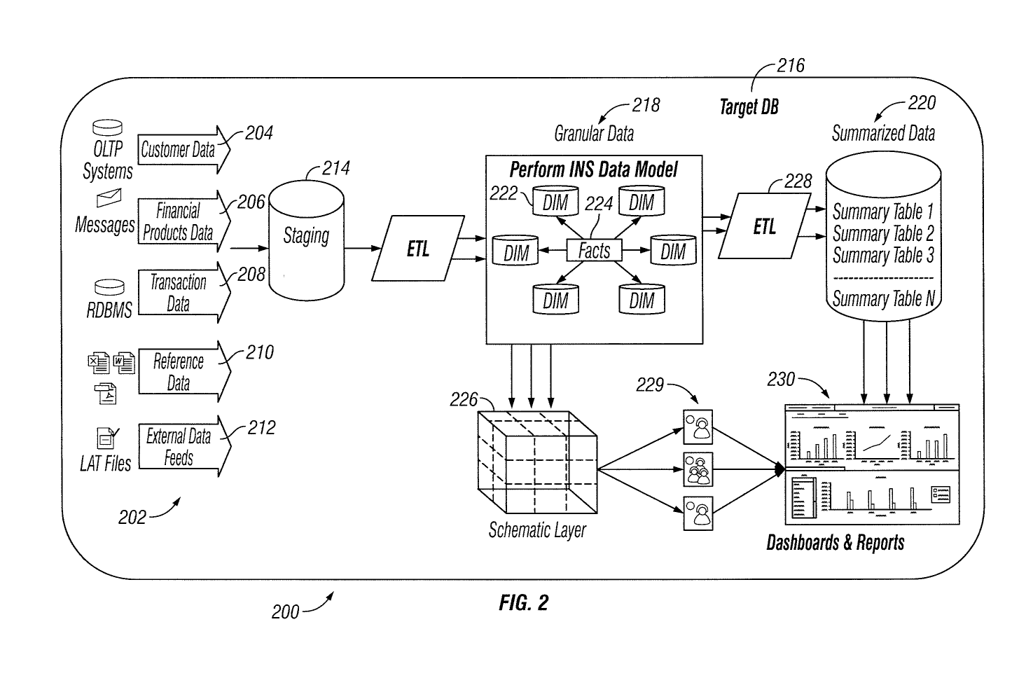

FIG. 2 is a diagrammatical representation of an embodiment of the reporting system 200. As shown, the system includes a plurality of data sources 202. In this example, the data sources 202 include customer data 204, financial products data 206, transactional data 208, reference data 210, and external data feeds 212. Although these data sources are provided for purposes of example, it should be appreciated that this is not intended to be an exhaustive list of data sources. Moreover, it should be appreciated that not all of the data sources shown in FIG. 2 will be provided in each embodiment depending on the circumstances. The data sources 202 are stored in a staging database 214 in this example.

The data in the staging database 214 is extracted, transformed and loaded (“ETL”) into a target database 216. In the example shown, the target database 216 may include a granular data portion 218 and a summarized data portion 220. In this example, the granular data portion 218 includes dim tables 222 and fact tables 224 for a data warehouse. This granular data 218 may be viewed by users through a schematic layer 226.

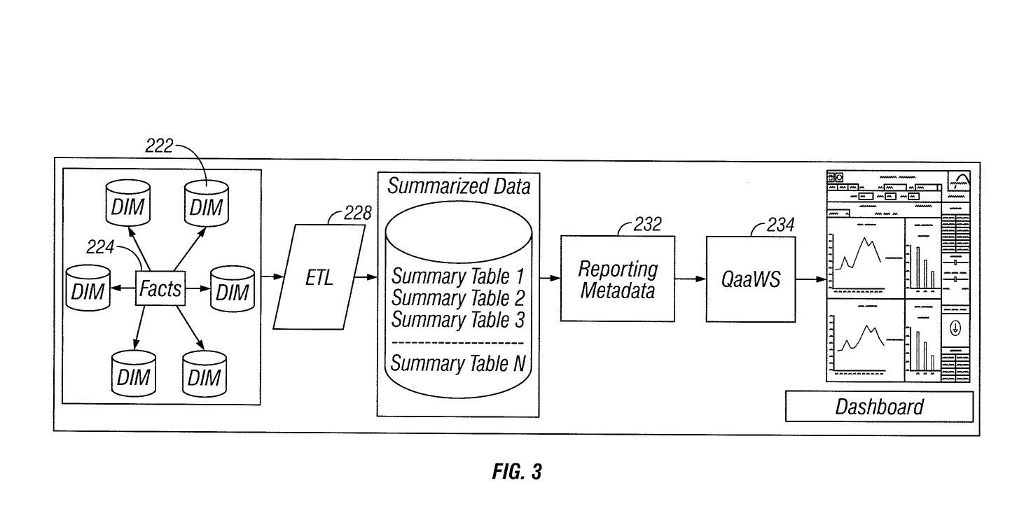

In the example shown in FIGS. 2 and 3, the granular data 218 is ETL 228 into summary tables, which are accessible to users 229 through dashboard/reports 230. The summary tables hold the pre-calculated data as per the dashboard requirement. The ETL 228 holds the business rules to populate summary data in a summary data model. In the embodiment shown, a reporting metadata framework 232 has been created and a web service is created using Query as a Web Service (“QaaWS”) 234. A uniform resource locator (“URL”) is generated for accessing the web service to fetch data at run-time from the database using the reporting metadata. In this example, the dashboard connects to the web service using an open source reporting tool, which could be by way of example Xcelsius™ by SAP of Waldorf, Germany. The dashboards and related reports can then be uploaded on an Internal/External Cloud based framework.

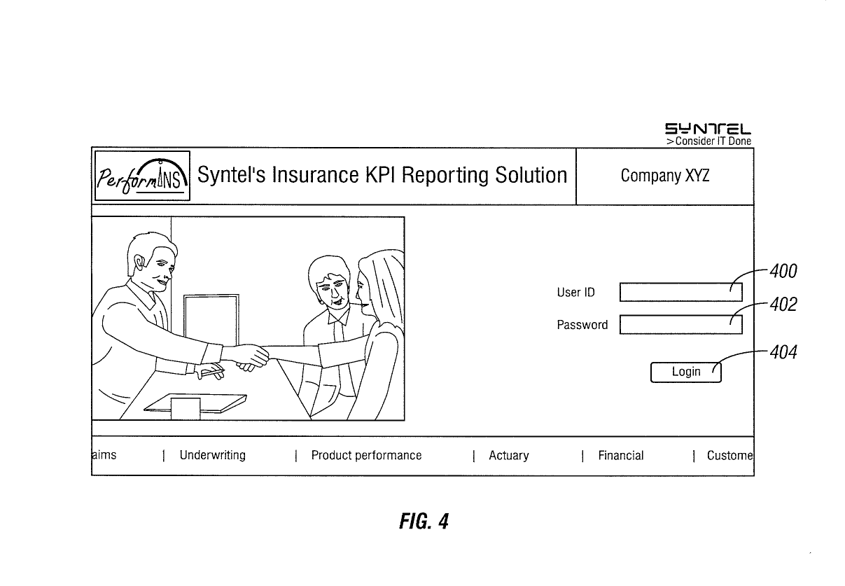

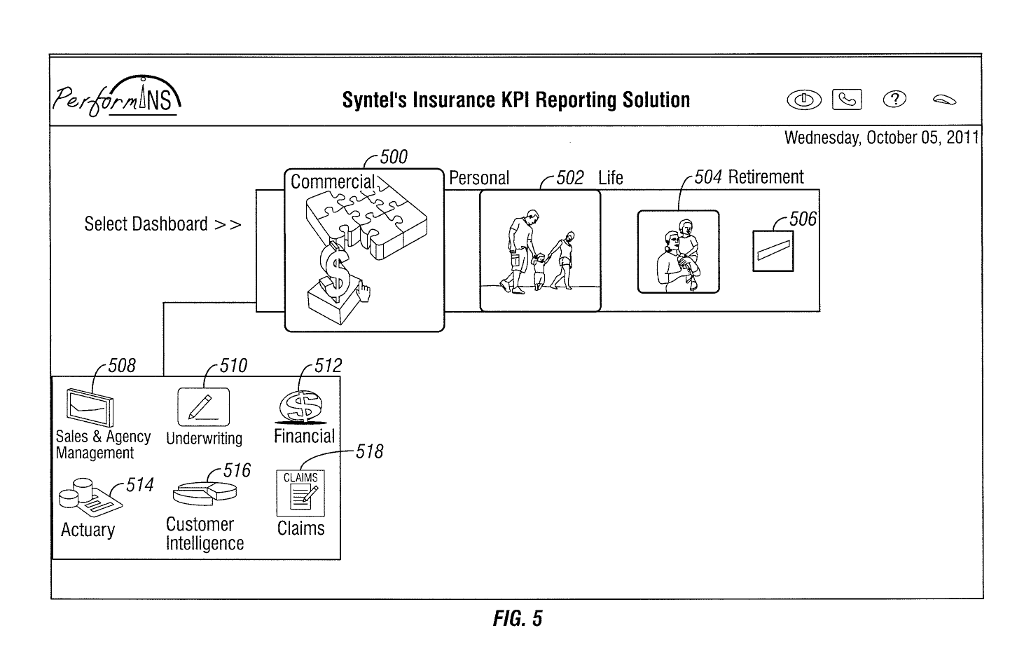

FIG. 4 is an example screen shot of a login screen of the system 200. In this example, the user is required to enter a username into a “User ID” textbox 400 and a password into a “Password” textbox 402. One skilled in the art should appreciate that other mechanisms could be used to authenticate the user. As discussed above, embodiments are contemplated in which the system could be role-based, which means that the user could have a customized view of dashboards and/or reports based on the type of user. Once the user enters a valid username and password and selects the “Login” button 404 in this example, the user could be presented with the interface shown in FIG. 5.

FIG. 5 is an example screen shot of an interface from which a user may select a dashboard to view. In this example, the user may select from the following categories of dashboards: commercial 500, personal 502, life 504, and retirement 506. Although these categories are presented for purposes of example, additional categories could be provided; likewise, some of these categories could be optional. As shown, the commercial category 500 is selected. In this example, the following dashboards are available to the user under the commercial category 500: sales and agency management 508, underwriting 510, financial 512, actuary 514, customer intelligence 516, and claims 518. Each of these dashboards provides the user with insight into performance indicators for the type of dashboard that is selected by the user.

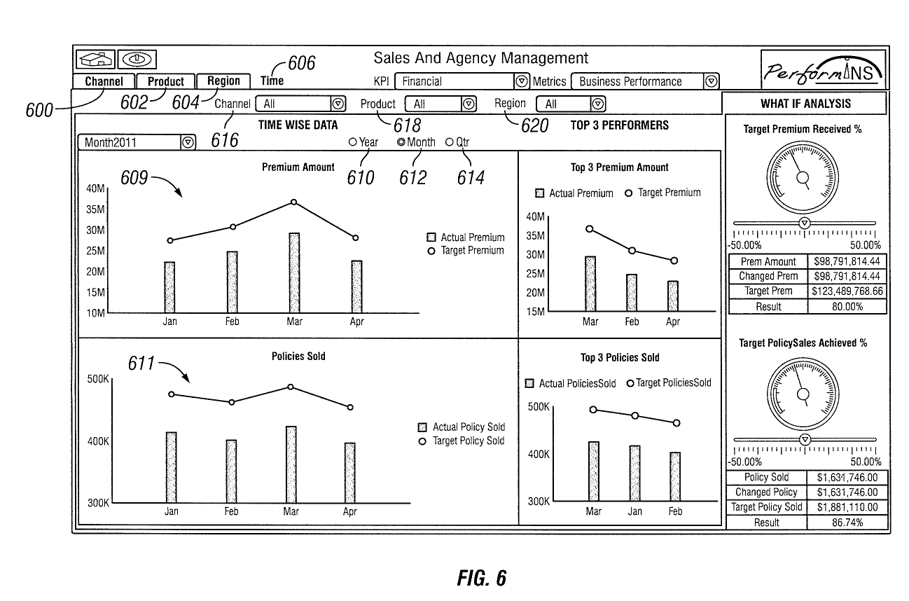

FIG. 6 is an example screen shot of a dashboard if the user selected the sales and agency management 508 dashboard shown in FIG. 5. In this example, the user is presented with information that can be surmised at a glance at a high level. As shown, the dashboard allows the user to select the manner by which the information is presented, either by channel 600, product 602, region 604, or time 606. In this example, the user has selected to view the information based on time.

In this example, the user may select both the KPI to review and the metrics. As shown, the user has selected Financial 508 as the KPI and Business Performance as the Metric. In the Time Wise Data region of the dashboard, the user is shown a premium amount chart 609 and a policies sold chart 611. The user may select a time period for the charts, such as a year 610, month 612, or quarter 614. In this example, the user has selected month, which causes the dashboard to present the user with charts in a month-wise fashion.

The dashboard allows the user to filter the data that is presented. In the example shown, the user may filter the data based on particular channels 616, products 618, or regions 620. As shown, the user has selected all data to be shown without any filtering. In this example, the dashboard includes a list of top performers. As shown, this correlates with the information provided in the charts under the time-wise data. For example, as shown, a chart is provided for the premium amount under time-wise data and the top performers are for the months with the top premium amounts. In the example shown, the dashboard includes a “what if” analysis. As shown, this analysis is shown in a gauge style with the needle on the gauge indicating whether the actual amount exceeded or was below the target amounts.

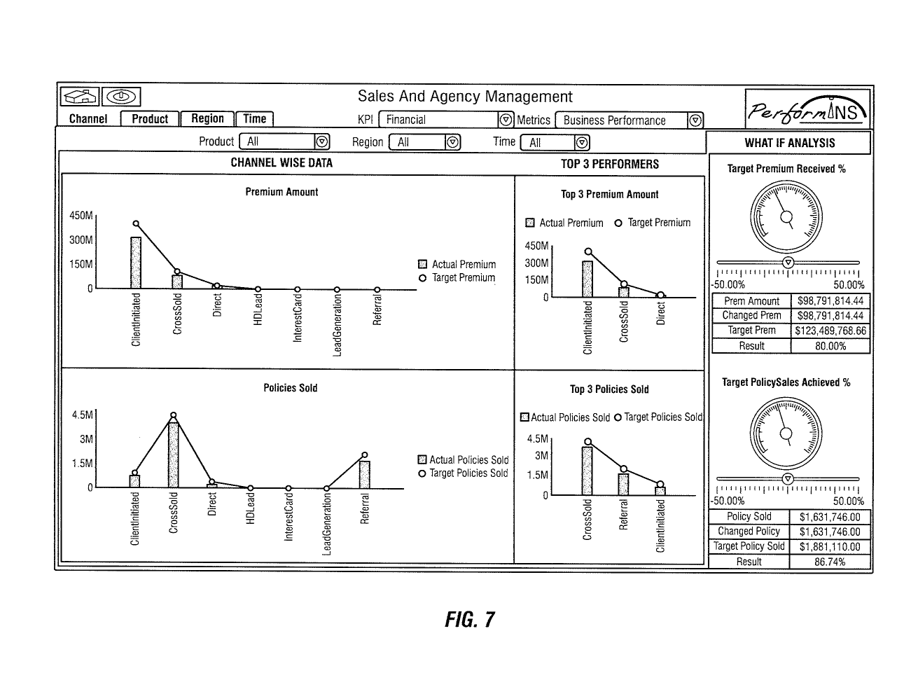

FIG. 7 is an example screen shot if the user selected the channel 600 in the dashboard shown in FIG. 6. Since the user has selected to view the information in a channel-wise manner, the charts show the information based on sales channels. In this example, the dashboard presentation is consistent with that shown in FIG. 6, except showing the data in a channel-wise fashion.

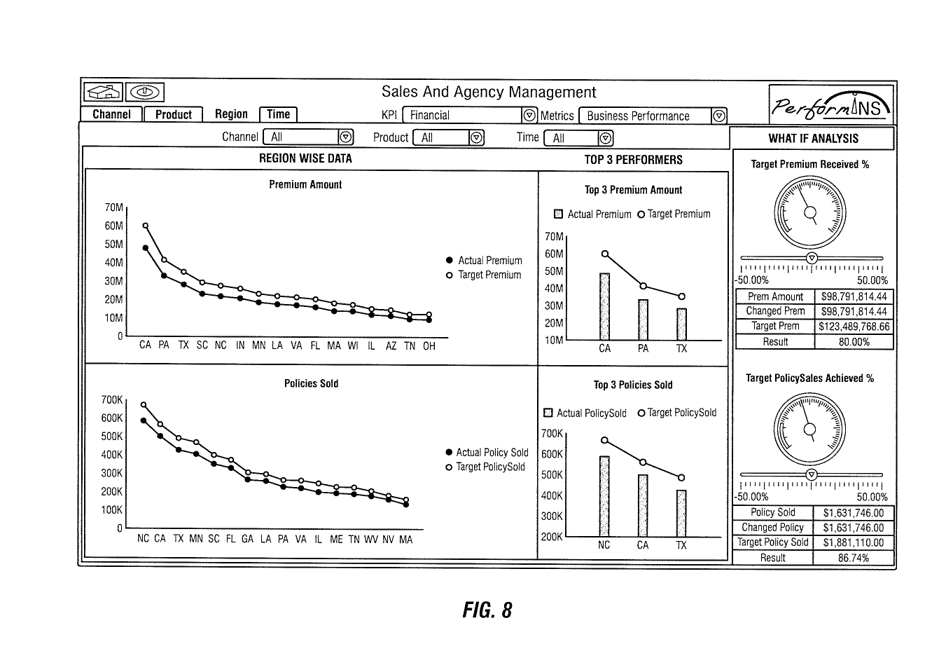

FIG. 8 is an example screen shot if the user selected the region 604 in the dashboard shown in FIG. 6. Since the user has selected to view the information in a region-wise manner, the charts show the information based on geographic regions. In this example, the dashboard presentation is consistent with that shown in FIGS. 6 and 7, except showing the data in a geographic region fashion.

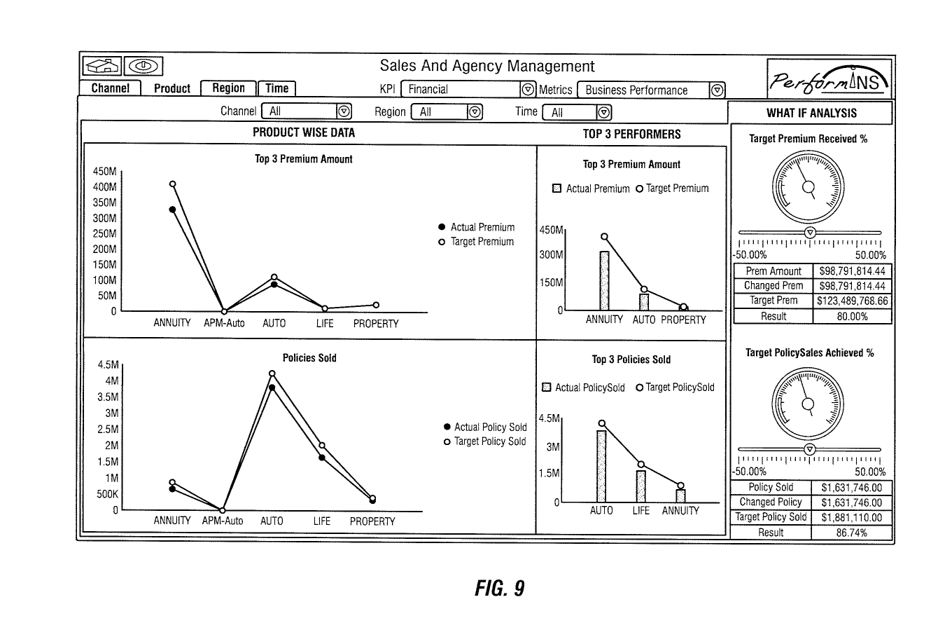

FIG. 9 is an example screen shot if the user selected the product 602 in the dashboard shown in FIG. 6. Since the user has selected to view the information in a product-by-product manner, the charts show the information based on products offered. In this example, the dashboard presentation is consistent with that shown in FIGS. 6, 7 and 8, except showing the data in a product-wise fashion.

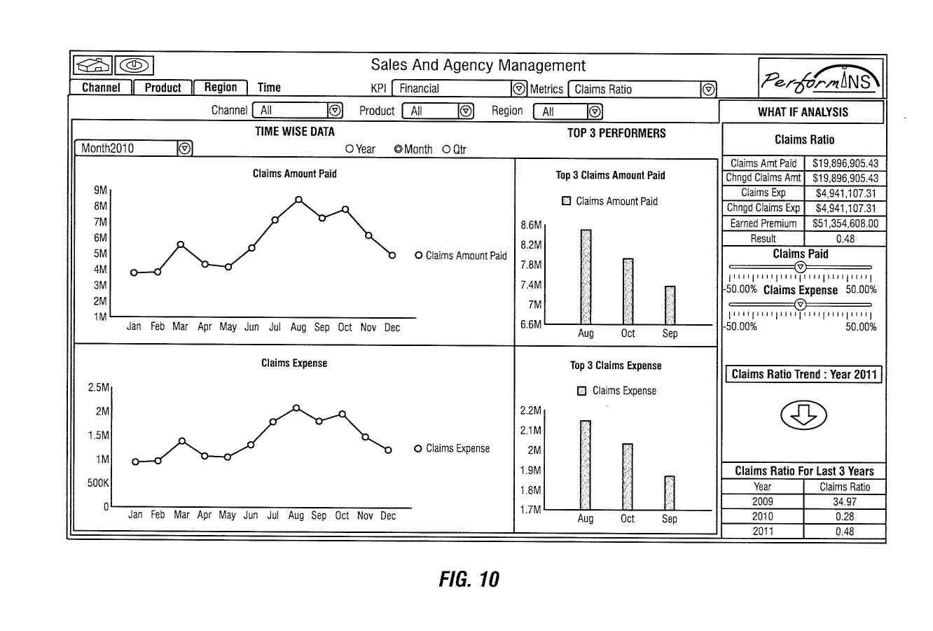

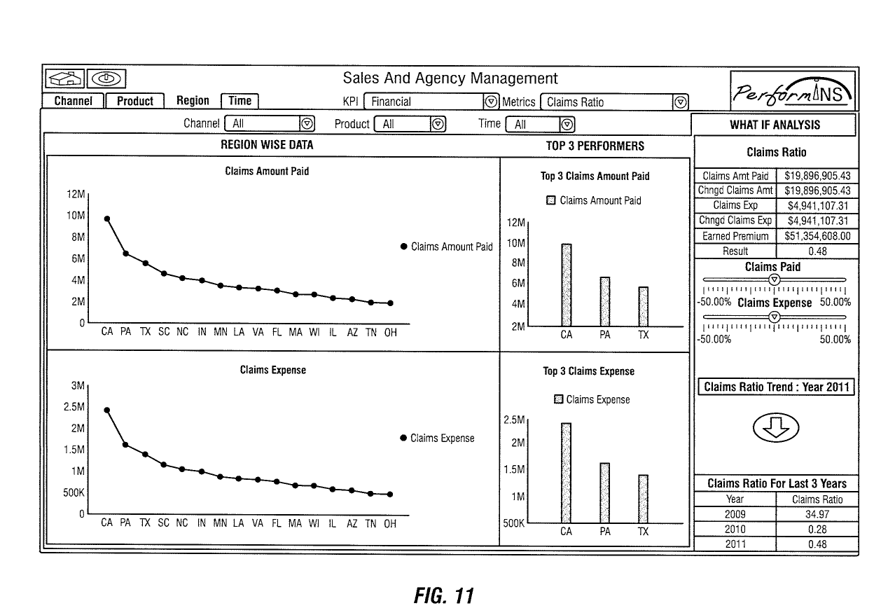

FIG. 10 is an example screen shot similar to FIG. 6, except in this example the user has selected a different metric of “claims ratio.” Accordingly, the data presented to the user uses the “claims ratio” metric instead of the “business performance” metric shown in FIG. 6. Embodiments are contemplated in which the user may select from a plurality of metrics as desired to view the source data. FIG. 11 is an example screen shot if the user selected the region 604 in the dashboard shown in FIG. 10. Since the user has selected to view the information in a region-wise manner, the charts show the information based on geographic regions.

Although the present disclosure has been described with reference to particular means, materials, and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. A computerized system comprising:
a target database having stored a plurality of summary tables containing business data about an insurance organization across an insurance cycle;
a dashboard on a computer configured to communicate with the target database, wherein the dashboard is configured to graphically display selectable portions of the business data about the insurance organization enabling views of key performance indicators (“KPIs”) across a plurality of business functions of the insurance organization.

2. The computerized system as recited in claim 1, wherein the dashboard includes a plurality of selectable views based on a plurality of user-selectable metrics.

3. The computerized system as recited in claim 2, wherein the plurality of metrics includes one or more of financial analysis, campaign analysis, business stability/growth, risk evaluation and assessment, claim financial, and claim efficiency.

4. The computerized system as recited in claim 3, wherein when the metric selected by the user is financial analysis, the dashboard is configured to graphically display the business data in a plurality of pre-defined, user-selectable reports, including one or more of business performance, cost of premium acquisition, claims ratio, cost of claims, total commission pay out, and net premium amount.

5. The computerized system as recited in claim 3, wherein when the metric selected by the user is campaign analysis, the dashboard is configured to graphically display the business data in a plurality of pre-defined reports, including one or more of lead performance, new business pipeline, customer response ratio, customer conversion ratio, and region-wise analysis.

6. The computerized system as recited in claim 3, wherein when the metric selected by the user is business stability/growth, the dashboard is configured to graphically display the business data in a plurality of pre-defined reports, including one or more of lapse analysis, customer retention rate, business lost, average policy size, policy renewal ratio-overall and line-of-business based, revenue from new products, and net premium amount.

7. The computerized system as recited in claim 3, wherein when the metric selected by the user is risk evaluation and assessment, the dashboard is configured to graphically display the business data in a plurality of pre-defined reports, including one or more of risk classification report, application rejection ratio, underwriting exposure analysis/catastrophe loss, and underwriting rejection loss of business.

8. The computerized system as recited in claim 3, wherein when the metric selected by the user is claim financial, the dashboard is configured to graphically display the business data in a plurality of pre-defined reports, including one or more of claims payment analysis, incurred claims ratio, claims handling expense ratio, reserve versus actual claims paid, average cost per claim, claims recovery, and claims loss ratio.

9. The computerized system as recited in claim 3, wherein when the metric selected by the user is claim efficiency, the dashboard is configured to graphically display the business data in a plurality of pre-defined reports, including one or more of litigation claims analysis, inactive claims KPI, claims rejection ratio, and claims complaints analysis.

10. The computerized system as recited in claim 1, wherein the dashboard is configured with authentication.

11. The computerized system as recited in claim 3, wherein the dashboard is configured to provide a customized view based on the authentication of the user.

12. The computerized system as recited in claim 1, wherein the dashboard includes a plurality of pre-configured views based on business segments of the insurance organization.

13. The computerized system as recited in claim 12, wherein the plurality of pre-configured views includes views of one or more of the following business segments: commercial, personal, life and retirement.

14. The computerized system of claim 1, wherein the dashboard is configured to selectively display the business data about the insurance organization based on selection of one or more of the following: channel, product, region and time.

15. The computerized system of claim 1, wherein the dashboard is configured to filter the business data shown based on one or more of the following: channels, products, and regions.

16. The computerized system of claim 1, wherein the dashboard is configured to visually indicate how the business data concerning a pre-defined metric compares with a target amount.

17. The computerized system of claim 16, wherein the dashboard is configured to visually represent the comparison between the business data and the target amount with a needle on a gauge indicating whether the business data exceeded or was below the target amount.

18. The computerized system of claim 1, wherein the dashboard is configured to be configure the visually represent the business data in a channel-wise fashion.

19. The computerized system of claim 1, wherein the dashboard is configured to visually represent the business data in a geographic region-wise fashion.

20. The computerized system of claim 1, wherein the dashboard is configured to visually represent the business data in a product-wise fashion.
